(19) United States
(12) Patent Application Publication
(10) Pub. No.: US 2007/0088931 A1
(43) Pub. Date: Apr. 19, 2007

(54) Method and apparatus to authorize cross-partition commands

(76) Inventors: Nobuyuki Osaki, Saratoga, CA (US); Akira Yamamoto, Sagamihara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/250,430

(22) Filed: Oct. 17, 2005

(51) Int. Cl. G06F 12/00

(52) U.S. Cl. 711/173

(57) ABSTRACT

When a storage system is logically separated into several partitions for security reasons, users are provided with a mechanism to operate cross-partition commands securely. When a first administrator of a first logical storage system configures a command which needs to have an access to a second logical storage system, a second administrator of the second logical storage system may authorize the command. When the first or the second logical storage system receives an instruction from one of the administrators to execute the command, the logical storage system checks the command to see if the command has been authorized by administrators of both logical storage systems. If the command has been so authorized, the command is executed. In this way, commands may be executed across logical partitions securely.

### BACKGROUND OF THE INVENTION

1. Field of the Invention

The invention relates generally to storage systems. More particularly, the invention relates to logically partitioned storage systems in which users have an access right to one logical partition, but do not have an access right to another logical partition.

2. Description of the Related Art

Generally speaking, the invention is directed to the situation where a storage system is logically partitioned into several logical storage systems. In this situation, a user, such as a storage administrator, who has an access right to one logical storage system, should not have an access right to another logical storage system managed by another administrator in order to ensure security of the logical storage systems. However, the case may sometimes occur that administrators or other users may want to execute an operation across the logical partitions, such as copying data from one logical partition to another. Such access is usually not permitted since, if a user was given access rights to both of the logical storages, such access may lead to a security breach, inadvertent loss of data, and the like.

U.S. Pat. No. 5,345,590, to Ault et al., entitled “Method and Apparatus for Cross-Partition Control in a Partitioned Process Environment”, discloses a method of allowing a cross-partition command in a data processing system wherein a large computer system including processors, storage and channels are logically partitioned. Although the partitions are on the same physical machine, programs running on the separate partitions normally have no means of communicating. However, Ault et al. provides a system whereby a workload in one partition may be transferred to another partition. Operating systems in these partitions enable themselves to be targets of cross-partition functions, and each operating system activates a policy to direct actions in the event of a failure of a system in another partition. If one such system fails, other systems interrogate their policies and take appropriate actions automatically, including acquiring resources from the failed partition by another system running in a different logical partition on the same machine. FIG. 3 of Ault et al. includes an “XLP” column which specifies whether a logical partition is authorized to issue cross-partition functions, such as the cross-partition system reset function, that affect other logical partitions. This information is maintained in a security control table 1803. However, the prior art does not make provision for a storage system that maintains logical partitions useable as separate storage systems by plural storage administrators, wherein a means is provided for ensuring security and limiting access to the logically partitioned storage systems while enabling limited operations across the logical partitions.

Other prior art that relates to logical partitioning of storage systems includes published US Patent Application No. US 2005/0050085, to Shimada et al., entitled “Apparatus and Method for Partitioning and Managing Subsystem Logics”, the entire disclosure of which is incorporated herein by reference.

### BRIEF SUMMARY OF THE INVENTION

According to a first aspect of the present invention, when a first administrator of a first logical storage system configures a command which requires an access to a second logical storage system, a second administrator of the second logical storage system authorizes the command.

Under another aspect, when the first or the second logical storage system receives an instruction to execute the command from one of the administrators, the logical storage system checks the command to see if it has been authorized by administrators of both logical storage systems. If so, the command is executed. This way, the storage system is enabled to execute commands across logical partitions securely.

Under yet other aspects, a management interface may maintain a table of commands that one administrator has requested and which an administrator of another logical storage system has authorized. Further, a command interface may be provided for each logical storage system for checking whether a command involves another logical storage system, and if so, whether the particular command is on the table of authorized commands.

Also, according to additional aspects of the present invention, even when the resources within one logical partition are unknown to others outside that partition, a request can still be made to utilize resources that satisfy certain defined parameters. Furthermore, virtual logical storage systems can be created to satisfy a request made by a command, whereby a particular configuration may be proposed for one logical storage system by another.

These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an example of hardware configuration of the invention according to one embodiment.

FIG. 2 illustrates a flow chart of a process for accepting a cross-partition command.

FIG. 3A illustrates an example of a cross-partition command.

FIGS. 3B and 3C illustrate examples of tables maintained in the management interface.

FIG. 3D illustrates an example of a requirement for a command.

FIG. 4 illustrates a flowchart of a process performed by the command interface.

FIG. 5 illustrates another embodiment of a hardware configuration of the invention.

FIG. 6 illustrates yet another embodiment of the hardware configuration of the invention.

FIG. 7 illustrates a flowchart of a process by which the management interface accepts a command.

FIG. 8 illustrates a flowchart of a process by which the command interface executes a command.

FIG. 9 illustrates an example of an application of the present invention.

FIG. 10 illustrates another example of an application of the present invention.

FIG. 11 illustrates a flowchart of a process involving resources of virtual logical storage systems.

FIG. 12A illustrates an example of a command involving a virtual logical storage system.

FIGS. 12B and 12C illustrate examples of tables maintained in the management interface.

FIG. 13 illustrates another embodiment of the present invention that involves a virtual logical system.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views.

### 1. Explanation of the System Configuration

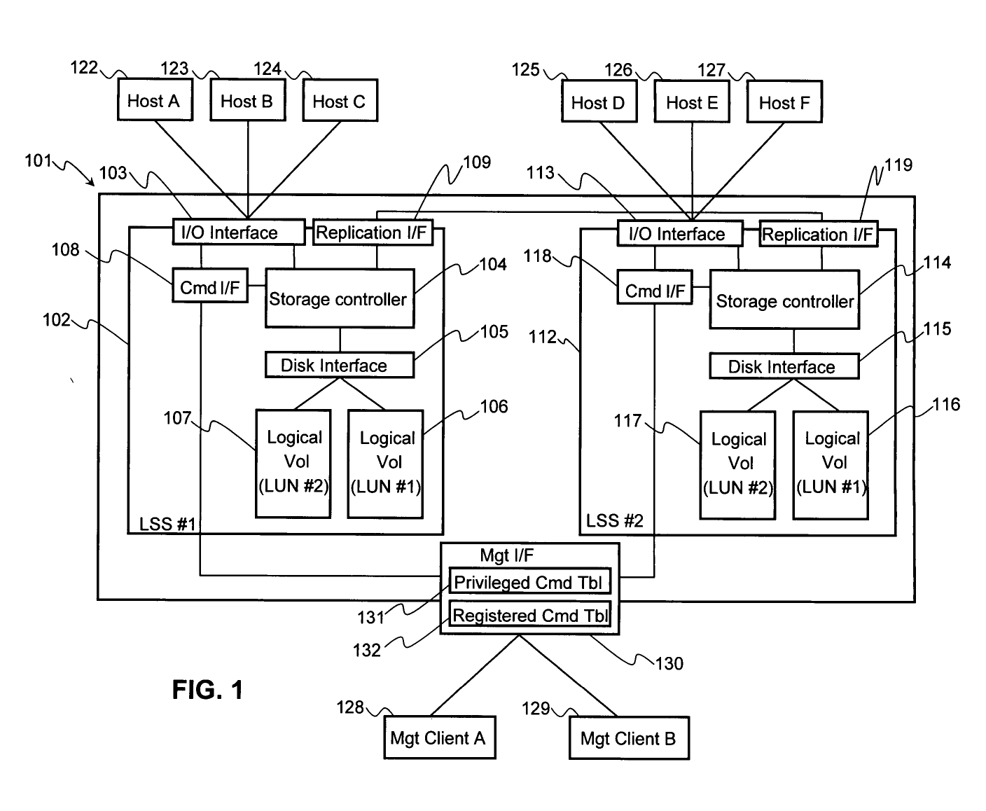

FIG. 1 illustrates a storage system 101 which as a capability to partition itself into several logical storage systems, such as 102 and 112. Storage system 101 includes I/O interfaces 103, 113: storage controllers 104, 114; disk interfaces 105, 115; logical volumes 106, 107, 116, 117; and command interfaces 108, 118 which receive commands from hosts via I/O interfaces 103, 113 or management interface 130. The commands are processed at the storage controllers 104, 114 and the results are returned. Storage system 101 also includes replication interfaces 109, 119, which are used to send or receive copy data between logical storage subsystems, and are used to send or receive instructions for the replication and configuration of the logical/physical storage systems involved in the replication. FIG. 1 also illustrates a plurality of hosts 122-126; management clients 128,129; and a management interface 130. Management interface 130 includes a privileged command table 131, which contains information on privileged commands, and a registered command table 132. The privileged command table 131 contains commands which the administrator of one LSS has requested and which the administrator of another LSS has agreed to. The registered command table 132 contains commands which have not been authorized by an administrator other than the administrator who put the command on the table. Commands may be on the registered command table merely because they do not need to be authorized by other administrators when the commands do not access resources of LSSs managed by other administrators. These two tables could be combined into a single table, but are differentiated here to better distinguish the two processes for adding commands to the tables.

The storage controllers 104, 114 receive I/O requests from hosts 122, 125, etc., through the I/O interfaces 103, 113, respectively, read or write data to the volumes 106, 107, 116, 117 through the disk interfaces 105, 115, respectively, according to the I/O request, and then return the results to the hosts through the I/O interface 103, 113. Hosts 122-124 have access to the logical storage system 102 (LSS#1), but not to storage system 112 (LSS#2). Hosts 125-127 have access to LSS#2 112, but not to LSS#1 102. The management client 128 is allowed to manage the resources and configuration of the logical storage system 102, while management client 129 is allowed to do the same for logical storage system 112. Thus, management client 128 would normally be used by a first storage administrator for managing LSS#1 102, while management client 129 would normally be used by a second storage administrator for managing LSS#2 112.

### 2. Explanation of System Operation

### 2.1 Scenario of Cross-Partition Operation

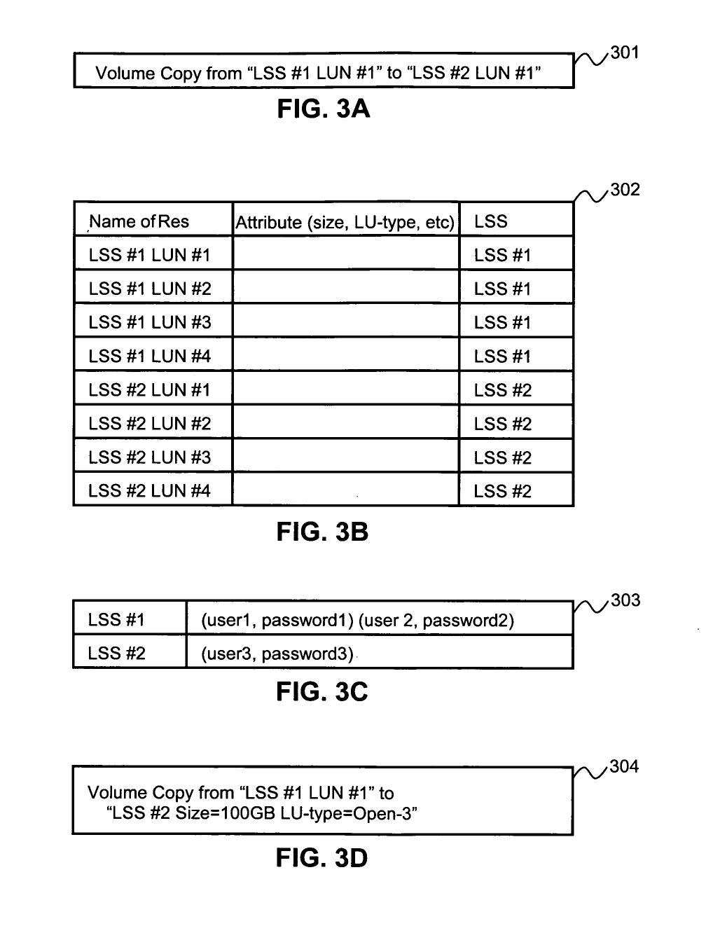

In one example, one or more of the hosts 122-124 may be application hosts that read and write data from and to the volume 106. It may be desired in this example to have all the data on the volume 106 on LSS#1 102 copied to volume 116 on LSS#2 112 for use by hosts 125-127, or for other purposes. The command to accomplish this may be of the form shown as 301 in FIG. 3A. The administrator of the logical storage system 102 (LSS#1) places the command from the management client 128 onto the management interface 130. The command is then authorized by the administrator of LSS#2 112. Then the command is configured. The detail of this configuration process is described below in section 2.2. The configured and authorized command to copy the data may be initiated by one of the hosts 122-124. The process is described below in section 2.3.

### 2.2 Configuring Cross-Partition Command

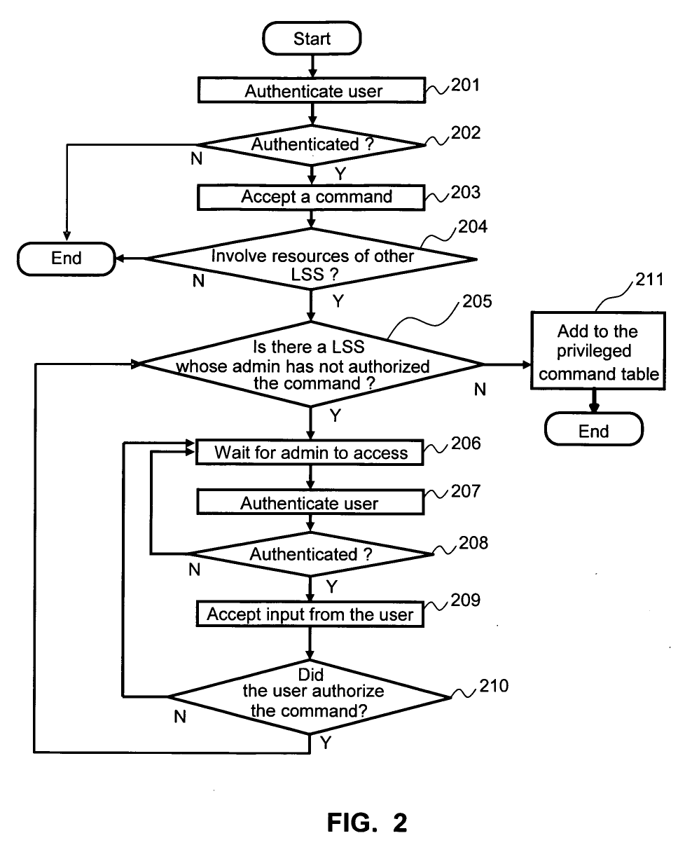

FIG. 2 illustrates the process of how the management interface 130 accepts the cross-partition command. User1 who is an administrator of the LSS#1 (102) logs onto the management interface 130 via management client 128. The management interface 130 authenticates the user as User1 at step 201. A table, such as user authentication table 303 in FIG. 3C, is maintained in the management interface 130 and used for the authentication of users. As an example, table 303 may contain a password or some other information for authentication. If the user is authenticated as User1 (step 202), the management interface accepts a command from the management client 128 and stores it in a registered command table 132 (step 203). Then the management interface 130 checks if the command involves any resources of other logical storage systems other than LSS#1 102 at step 204. If not, the process ends.

However, if the command does involve resources of an LSS other than LSS#1, the process goes to step 205. In the case of the command specified in 301 in FIG. 3A, the command involves the resource LUN#1 (116) of the logical storage system 112 (LSS#2) which is “LSS#2 LUN#1”. The management interface 130 determines which logical storage system a resource belongs to using a resource allocation table 302, an example of which is illustrated in FIG. 3B.

At step 205, the management interface 130 checks whether there is an LSS whose administrator has not authorized the command. In this example, as shown by table 303 in FIG. 303, User 3 is an administrator of the LSS#2 112. If User 3 has not authorized the command, the process goes to step 206.

At step 206, the management interface 130 waits until User 3 accesses the system. When User 3 logs on to the management interface 130, the management interface 130 authenticates User 3 at step 207. If the user is authenticated as User 3, using table 303, the management interface 130 gives User 3 the right to authorize outside access to the resources which belong to his/her group, which is LSS#2 112. In this case, the resource turns out to be “LSS#2 LUN#1”, as shown in table 302 (step 209) of FIG. 3B. If User 3 authorizes the command (step 210), the process goes back to step 205. The above process is repeated until there is no LSS resource which is involved in the command but not authorized. When there no longer remains an affected LSS whose administrator has not authorized the command, the management interface 130 adds the command to the privileged command table 131 (step 211).

If the user is not authenticated at step 208, the process goes back to step 206. The process may go back to step 207 to re-authenticate the user. In either case, the management interface may have a mechanism to avoid repetitive re-authentication attempts from a certain user, such as blocking the account after a certain number of consecutive failed attempts. If the user does not authenticate the command after reviewing the content of the command, the process goes to 206. In such case, the command will never be authorized unless it is modified, or the command may be discarded.

The process described by FIG. 2 illustrates an embodiment in which the second administrator is informed of the situation that he/she needs to access the system and authorize a command requesting access from another LSS to the LSS that he/she manages. The second administrator will be informed of this verbally, via e-mail or via a workflow system which carries a notification that the person has a task that requires attention.

### 2.3 Executing the Cross-Partition Command

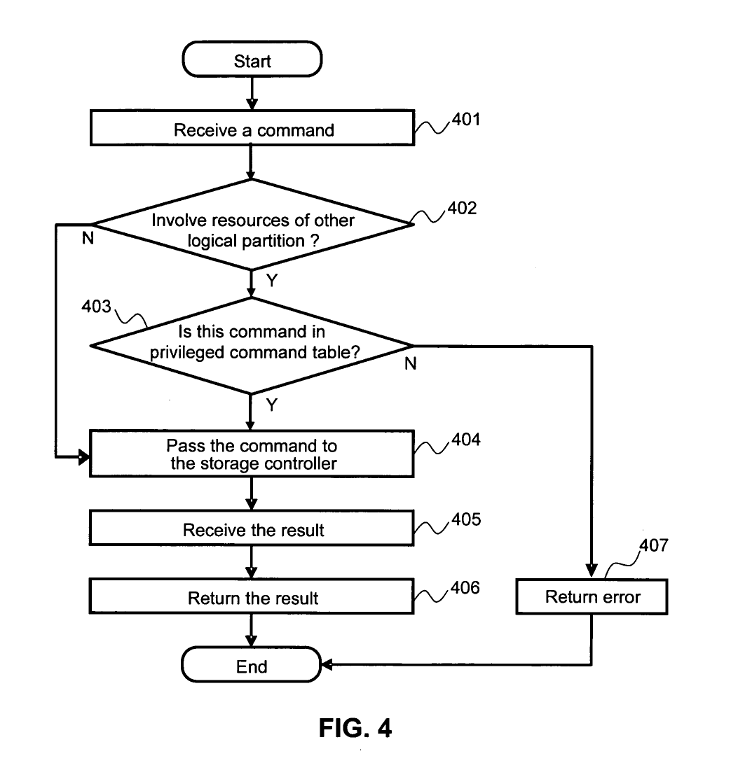

FIG. 4 explains the process of how the command interface 108 of LSS#1 (102) executes a cross-partition command. The command interface 108 receives a command via the I/O interface 103, the management interface 130 or the replication interface 109 (Step 401). The command interface 108 checks whether the received command involves resources of the logical storage systems other than LSS#1 102 (step 402). If so, the command interface 108 checks if the command is on the privileged command table 131 (step 403). If the command is on the privileged command table 131, or if the command does not include any resources of the other logical storage systems, the command interface 108 passes the command to the storage controller 104 (step 404). The storage controller 104 processes the command and returns the result of the process to the command interface 108 (step 405). Then the command interface 108 returns the result to the interface from which the command interface 108 received the command. If the command is not on the privileged command table 131, the command interface 108 returns an error (407).

The command interface 118 of LSS#2 112 also functions according to the flow of FIG. 4 when it receives a second command related to the command received by command interface 108, discussed immediately above. In this scenario, the first command, which the command interface 108 receives, instructs LSS#1 102 to initiate sending data, while the second command, which the command interface 118 receives, instructs LSS#2 112 to initiate receiving data.

### 3. Modifications to Previous Embodiments

### 3.1 Privileged Command Table

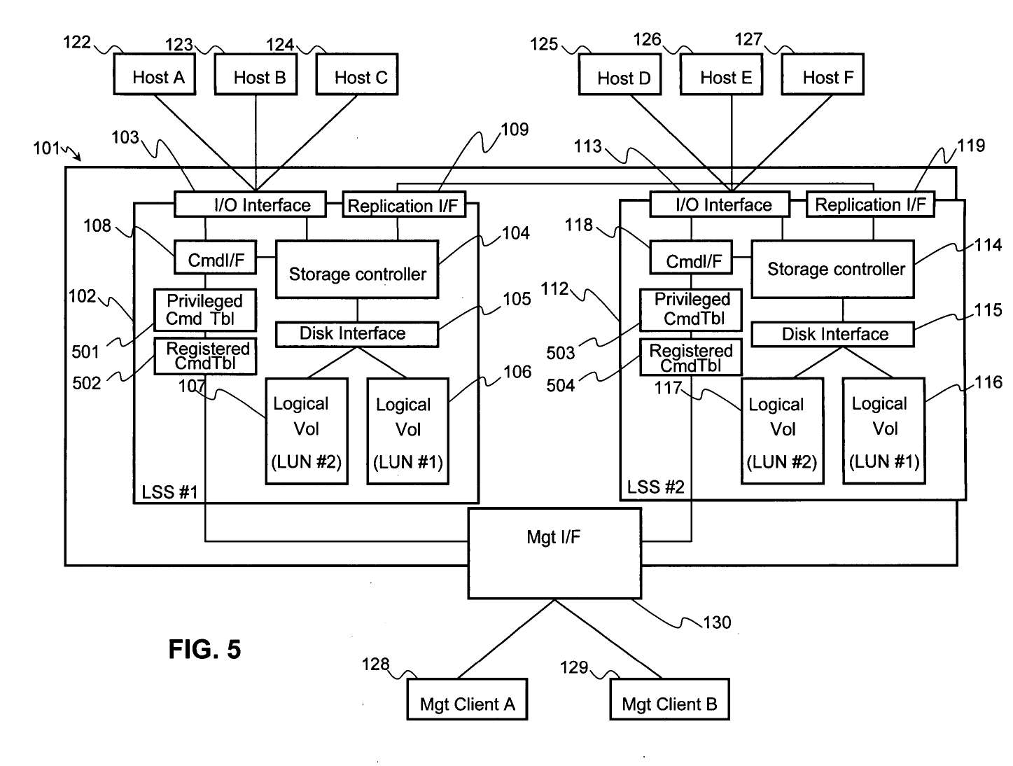

In FIG. 1, there is one privileged command table. However, it does not necessarily need to be centralized in this manner. In an alternative embodiment illustrated in FIG. 5, each logical storage system may have a privileged command table 501, 503, respectively. If the privileged command table is not centralized, the multiple privileged command tables should be distributed appropriately after the configuration of the table is added, changed or deleted. Furthermore, the privileged command table may be stored outside of the storage systems, e.g., on hosts 122-127. In such a case, the command interface 108 or 118 may not check the privileged command table as specified in steps 402 and 403. Instead a program running on a host which issues an instruction to initiate a command may check the privileged command table on the host to determine if the command is allowed or not.

### 3.2 Process When Information on the Resources in Other Logical Storage Systems is Not Available.

When a volume level copy is configured, it may be required that the target volume have specific attributes such as the same attributes as the source volume such as size and LU type. In the previous embodiment described above, it was assumed that User 1 of LSS#1 102 knows the specification of the volume 116 in the LSS#2 112, or at least knows that volume 106 can be copied to the volume 116. However, in a logically partitioned environment, User 1, as administrator of LSS#1 102, may not know such information about the resources in the other logical storage systems.

In such a case, the following process may be employed. At step 203 of the flowchart of FIG. 2, instead of providing a command such as 301 in FIG. 3A, which includes information on the resource of the other logical storage system, User 1 can provide the management interface 130 with the requirement for the command as is shown in item 304 in FIG. 3D. Command 304 indicates that the command is to copy from volume 106 (LSS #1 LUN#1) to another volume having the attributes of 100 GB of capacity and an LU type being Open-3. Furthermore, at step 209 of FIG. 2, in addition to authorizing the command, User 3 provides the management interface 130 with the information on a specific volume as a target volume, which is volume 116. If there is no extra volume which has the required attributes and can be used for the current purpose, a new volume may be created at this point if the command is to be authorized.

### 3.3 Use of Virtual Resource Name

Additionally, User 1 is not necessarily able to see the actual names of the resources of LSS#2 112. Or, the resource names which User 1 can see are not necessarily the same as the names by which the resources are called in the LSS#2 112. In such a case, LSS#2 112 can have a translation table to map the real resource name and virtual resource name which is disclosed to the outside. For example, LSS #2 LUN #1 may be a public name of the volume 116 disclosed to other logical storage systems and LSS#2 112 may be using another name internally. In such case, the logical storage system 112 can have a translation table to map “LSS #2 LUN #1” to the actual internal name.

### 3.4 Other Variations

In the embodiment described above, the process to execute a command is divided into two phases, namely configuration followed by execution. However, this is not always the case. Some commands may be executed immediately after step 211 of FIG. 2. In such case, steps 401-403 of FIG. 4 may be omitted, for example.

In step 403, the command received by the command interface 108 is compared with the commands in the privileged command table 131 to see if the command has been authorized or not. However, the comparison does not have to comprise checking for an exact match. The command listed in the privileged command table 131 may represent a set of commands. For example, when a command such as that specified in 301 is listed on the privileged command table 131, any commands related to a volume copy operation from LSS #1 LUN #1 to LSS #2 LUN #1 may be authorized. For example, starting the copy, suspending the copy, and resuming the copy may be authorized when they are listed as a family command of the command specified in 301.

In the flowchart of FIG. 2, authorization is required when a command is added. However, authorization will be also required by the administrators whose resources are involved in the command when the command is modified or deleted.

In the above embodiment, volume copy from the logical storage system 102 to the logical storage system 112 is described. The following are other examples of cross-partition commands:

Borrowing (renting) resources of other logical storage systems. Examples of the resources that might be borrowed or utilized temporarily include data volumes, cache memory and network resources. These resources may be used to increase the performance of the borrowing LSS.

Reading/writing data on the volume of other logical storage systems.

Furthermore, Fibre Channel protocol as a protocol for an I/O interface has a server level authentication capability, i.e., access to ports and LUs can be limited using the information of server WWN (world wide name). User level authentication is not provided by current standards, which are critical to comply with in order to ensure interoperability. On the other hand, a management interface can be proprietary and is often provided over an IP network. A management interface can provide more granular authentication, such as user level authentication. Such granular authentication is more effective for authentication, in particular as shown in FIG. 2.

### 4. Additional Embodiment

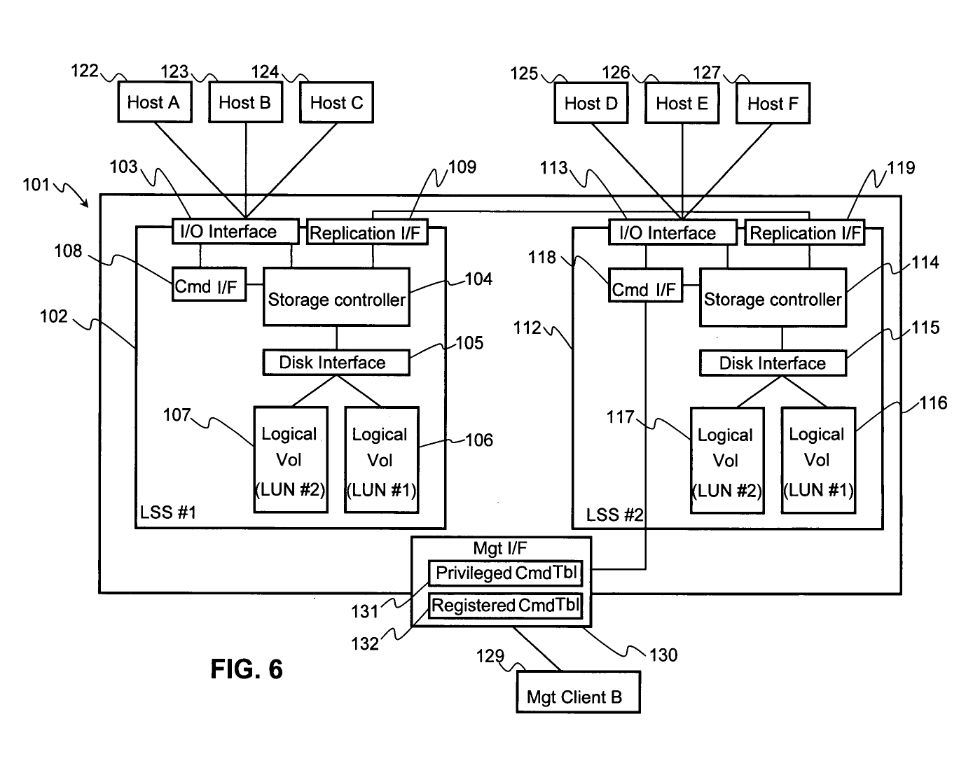

FIG. 6 shows another embodiment of the invention. In this embodiment, a specific set of single-partition commands are allowed for the command interface 118 of LSS#2 112, and access to the command interface 118 is allowed to hosts belonging to the group of the LSS#1 102. The details are explained below. Because the administrator of LSS#2 112 puts a specific set of commands in the privileged command table 131 in advance, all of the commands which the administrator of LSS#1 102 can perform can be limited to those that are allowed by the administrator of LSS#1.

### 4.1 Configuring Command

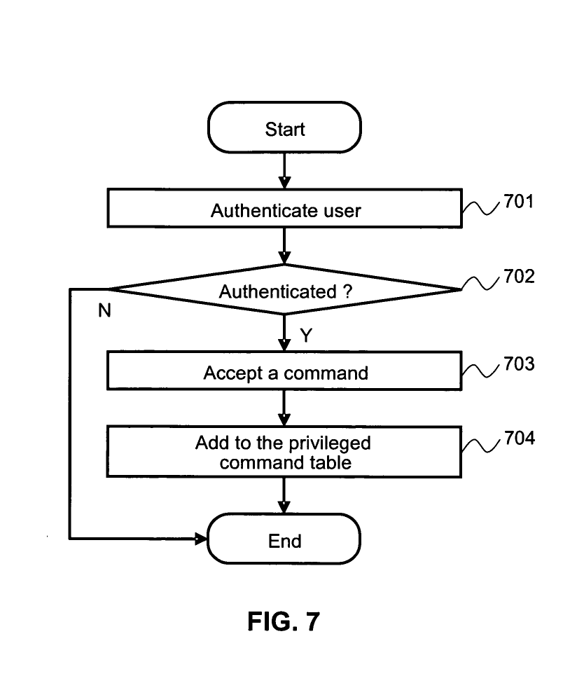

FIG. 7 explains the process of how the management interface 130 accepts commands. When User 3 (having administrative privileges on LSS#2 112) logs on to the management interface 130, the management interface 130 authenticates the user at step 701. If the user is authenticated as User 3 (Step 702), the management interface 130 accepts a command from User 3 at step 703 and then adds the command to the privileged command table 131 (Step 704). The privileged command table 131 can be on the management interface 130 or in the LSS#2 112. The command interface 118 is set to allow access from users or servers belonging to the other logical storage system(s), in this case the LSS#1 102.

### 4.2 Executing the Command

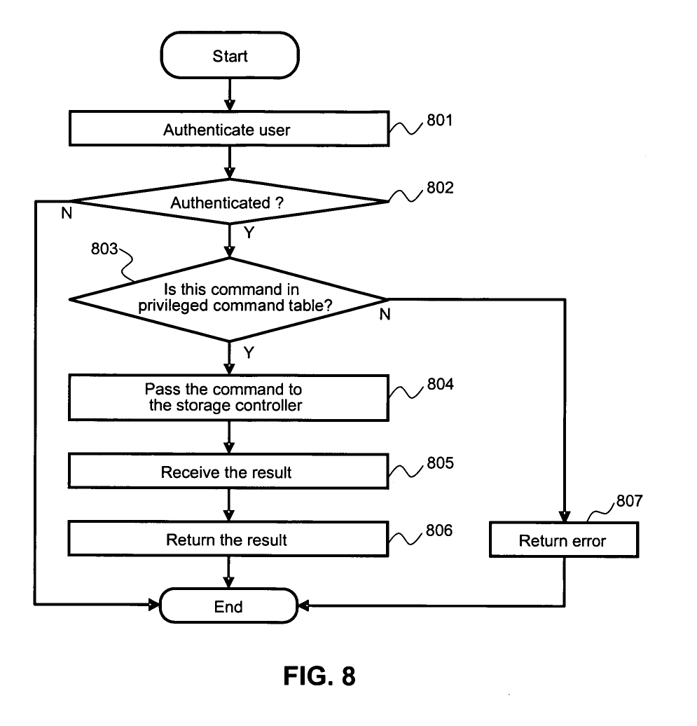

FIG. 8 explains how the command interface 118 of LSS#2 112 executes the command. When a user or a server belonging to the group of LSS#1 102, such as Host A 122, accesses the command interface 118 of LSS#2 112, the command interface 118 authenticates the user (steps 801 and 802). If the user is authenticated, the command interface 118 checks if the command is on the privileged command table 131 (step 803). If it is, the command interface 118 passes the command to the storage controller 114 of LSS#2 112 so that the command is processed (step 804). When the command interface 118 receives the result (step 805), the command interface 118 returns the result to the user who issued the command (step 806). If the command is not on the privileged command table 131, an error is returned (step 807).

### 5. Additional Embodiment

In the first embodiment, it may happen that User 1 can not see the information of the resources of LSS #2. The method explained in section 3.2 is one solution to this problem. Another solution is explained in this section.

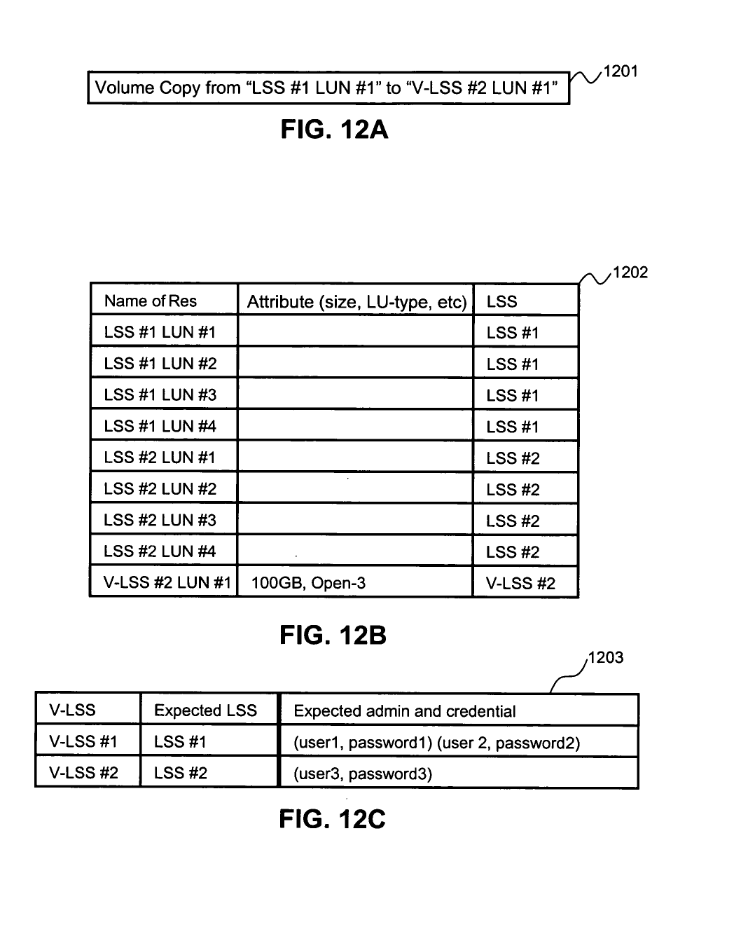

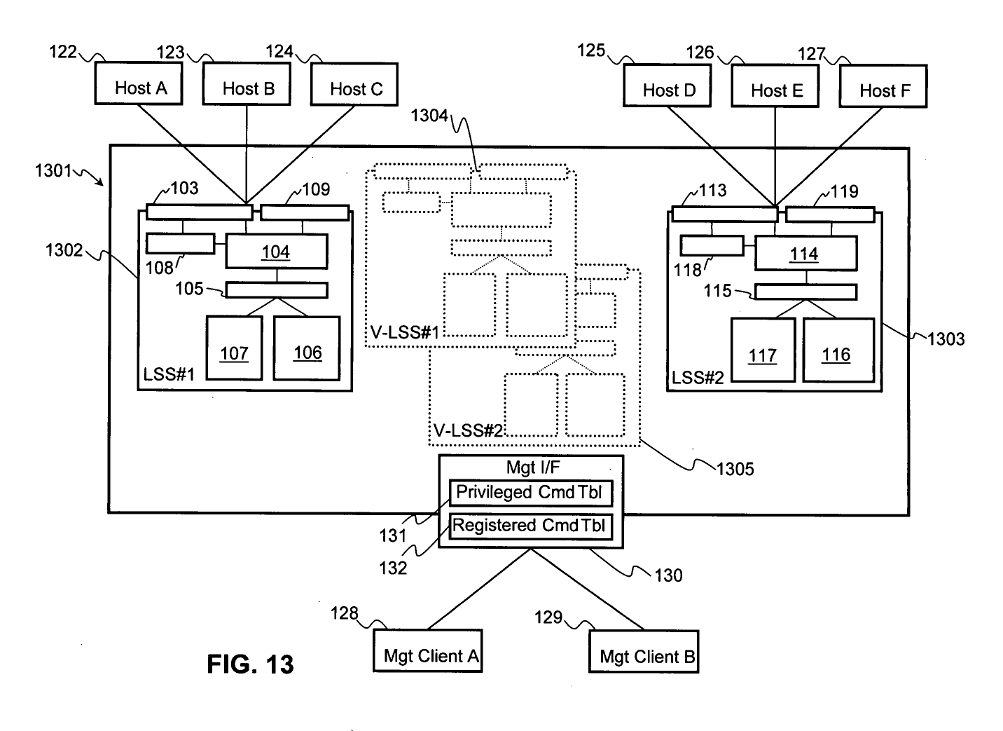

When a user wants to add a command which involves N number of LSSs (logical storage systems), N number of V-LSSs (Virtual Logical Storage Systems) are prepared. In FIG. 13,1304 and 1305 are the examples of the V-LSSs. If User 1 wants to add a command which is specified in 301, but he/she does not know the information of the resource of LSS #2 LUN #1, V-LSS #2 LUN #1 is created. The specification of the virtual resources is described in a specification table 1202, illustrated in FIG. 12B, and the command can be as shown in command 1201 in FIG. 12A. Each V-LSS has an attribute of “expected LSS” and specified in an expected attribute table 1203, as illustrated in FIG. 12C. If the administrator of the LSS #2 authorizes the command, the configuration of the V-LSS #2 is imported to LSS#2 for use by LSS#2.

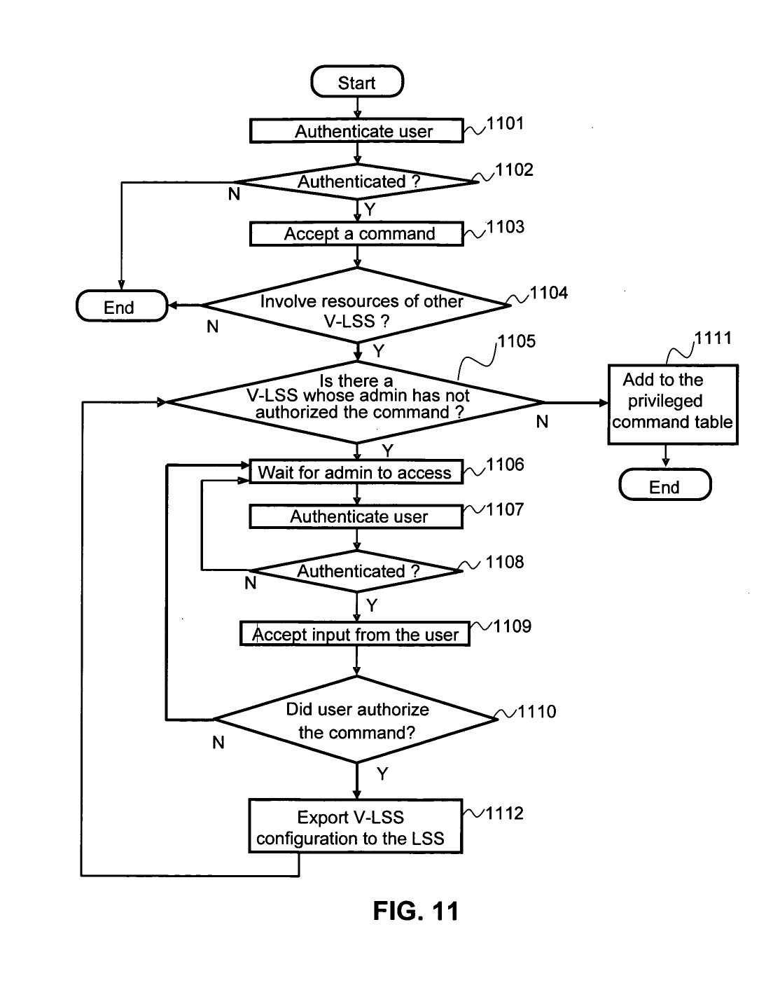

FIG. 11 illustrates an example of this process. The flow of FIG. 11 is similar to that of FIG. 2. In steps 1101 and 1102, the user is authorized by the management interface. The command the user inputs at step 1103 includes a V-LSS. At step 1104, management interface 130 examines if the command involves resources of any V-LSSs other that those accessible to the user. At step 1105, the management interface 130 examines if there is a V-LSS whose administrator (user) has not authorized the command. Steps 1106-1110 refer to such authorization and are similar to corresponding steps 206-210 of FIG. 2. If the administrator of the LSS authorizes the command at step 1110, the configuration information of V-LSS is exported to the expected LSS at step 1112. For example, when the specification of V-LSS #2 LUN#1 is “the size is 100 GB, LU-type is Open-3”, then LSS#2 creates a LUN whose size is 100 GB and LU-type is Open-3, then replaces the V-LSS#2 LUN#1 of the command 1201 with the created LUN. At step 1111, the replaced command is added in the privileged command table. The execution process described in section 2.3 above can be applied to this embodiment as well.

### 6. Examples of Use of the Invention

### 6.1 First Example of Usage

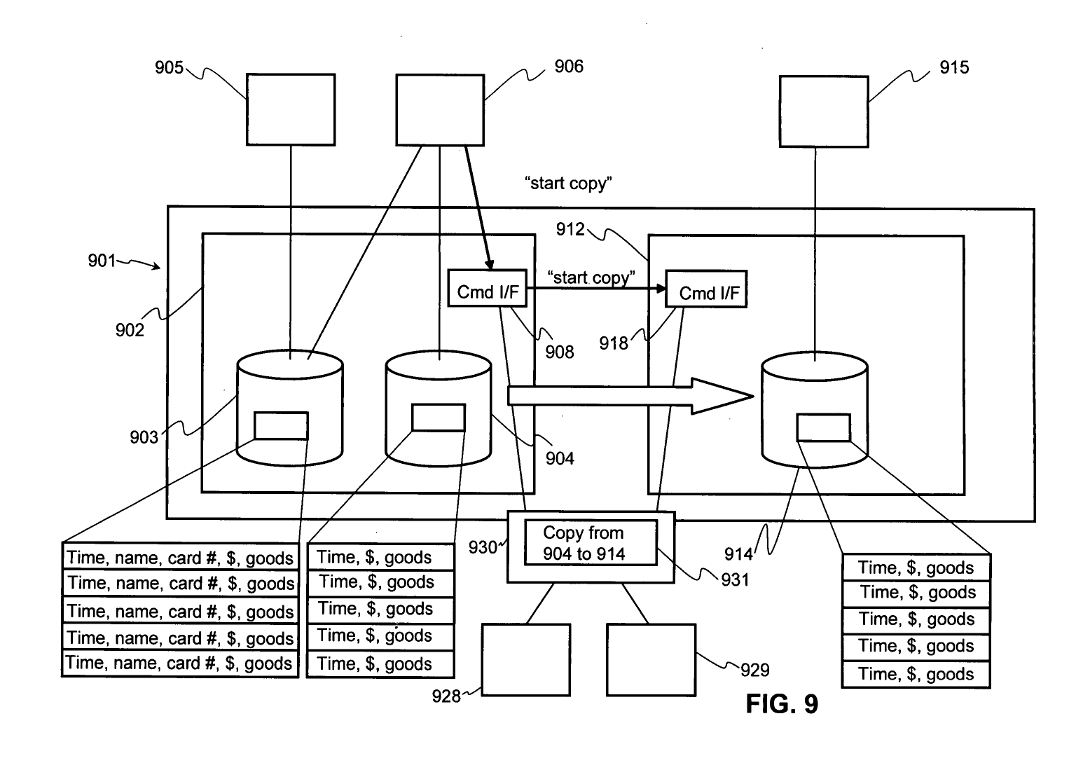

FIG. 9 illustrates an example of a situation in which the invention might be used. Storage system 901 is owned by a certain credit transaction processing company “company A”, which is provided with the functionality of the present invention. Storage system 901 is logically partitioned into two LSSs, 902 and 912. There are two groups in the company, the first group is a Transaction Processing Group and has detailed customer information such as customer name, card number, purchased goods, the price of the goods, etc. Customer names and card numbers need to be kept confidential from other groups. Because of this reason, the storage system 901 is logically partitioned. The second group is Transaction Statistics Analysis Group which does not need to know such detailed information, such as customer names and card numbers, but needs to know the number of the transactions and the amount of money processed by the company. LSS 902 belongs to the first group. The hosts 905, 906 and the management client 928 also belong to the first group, while LSS 912, the host 915, and the management client 929 belong to the second group. Host 905 in the first group writes credit transaction data including customer data on the volume 903. Host 906 extracts information of number of transactions and the amount of money processed by the company and writes the information on the volume 904. Volume copy from the volume 904 in the LSS 902 to the volume 914 in the LSS 912 is registered in the privileged command table 931 of management interface 930. As explained, the command has been authorized by the administrators of the first group and the second group.

The host 906 issues a command to start the copy. The command interface 908 executes the command, i.e., sending data, according to FIG. 4. Also the command is sent to the command interface 918 from the logical storage system 902 via a replication interface, and the command interface 918 will execute the command, i.e., receiving data, according to FIG. 4 in volume 914.

### 6.2 Second Example of Usage

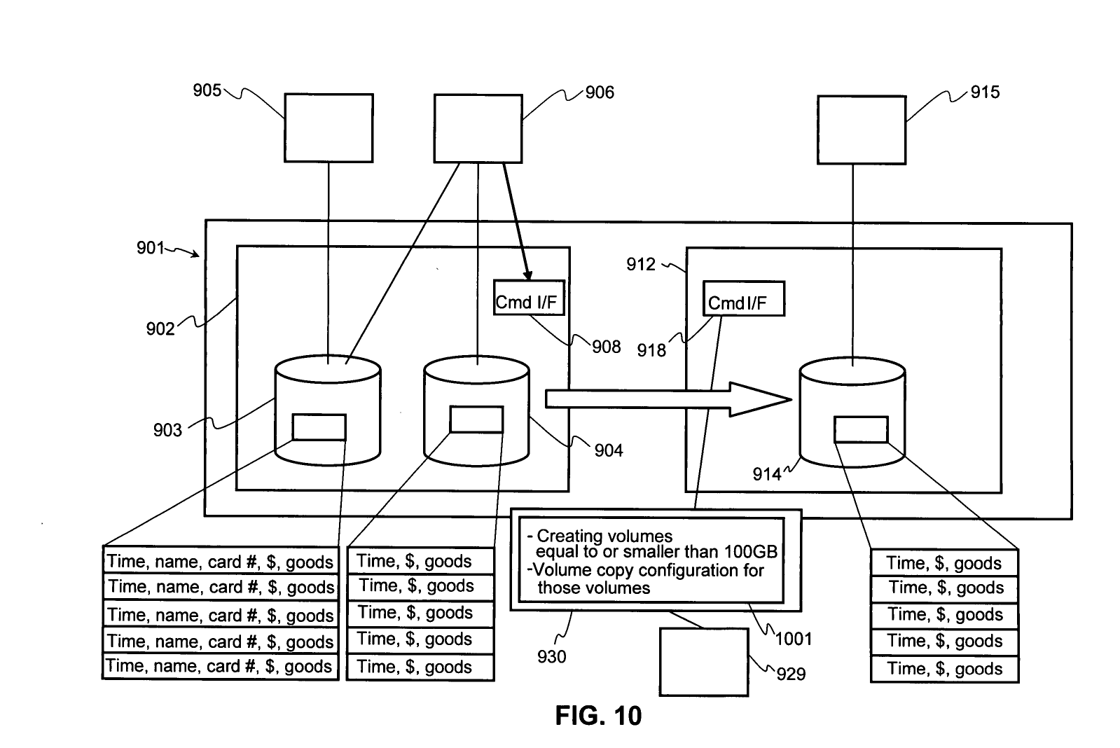

FIG. 10 illustrates a second example of usage of the present invention that has a configuration similar to that described above with respect to FIG. 9. However, according to FIG. 10, the servers belonging to the first group can access the command interface 918. As shown by block 1001, the command interface 918 is allowed to create volumes whose total capacity is smaller than 100 GB, and can use the volume. Therefore, once a volume with 100 GB capacity is created, the administrators belonging to the first group are allowed to configure volume copy operations which involve these volumes. This enables administrators in the first group to copy data to the second group as necessary.

While specific embodiments have been illustrated and described in this specification, those of ordinary skill in the art will appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

1. A method of executing a command across logical partitions in a storage system comprising the steps of:
providing in said storage system a first logically partitioned storage system and a second logically partitioned storage system;
initiating a command requiring access to both logically partitioned storage systems;
determining whether the command is registered as being permitted to be executed with respect to said first and second logically partitioned storage systems; and
upon determining that the command is registered, executing the command.

2. The method according to claim 1, further comprising the steps of:
registering the command by authorization from a first administrator of the first logically partitioned storage system and by authorization of a second administrator of the second logically partitioned storage system, and
wherein once the first and second administrators have authorized the particular command, the command is registered by storing in a predefined table.

3. The method according to claim 2, further comprising the step of storing the predefined table externally of the storage system.

4. The method according to claim 1, wherein the step of initiating the command includes the step of initiating a volume copy command, such that a first volume in the first logically partitioned storage system is copied to a second volume in the second logically partitioned storage system.

5. The method according to claim 1, wherein the step of initiating the command includes the step of initiating a command that is a request by the administrator of one of said first and second logically partitioned storage systems to temporarily utilize resources of the other one of said first and second logically partitioned storage systems.

6. The method according to claim 2, further comprising the steps of authenticating the first and second administrators by a management interface prior to the administrators being allowed to authorize the command.

7. The method of claim 1 further including the step of:
providing a management interface for the storage system and a command interface for each logically partitioned storage system,
wherein, said management interface includes a table of permitted commands for one of said logically partitioned storage systems to carryout with respect to another of said logically partitioned storage systems, and
wherein said command interface in each logically partitioned storage system determines whether the command is authorized.

8. A method of executing a command across logically partitioned storage systems, comprising the steps of:
providing a first logically partitioned storage system and a second logically partitioned storage system;
if the command involves the resources of more than one of said logically partitioned storage systems, determining whether execution of the command has been authorized by administrators of said first and second logically partitioned storage systems; and
if it is determined that execution of the command has not been authorized by one of the administrators, waiting until authorization is received from this one administrator prior to executing the command.

9. The method according to claim 8, further including the step of registering the command in a predefined table upon receiving authorization for execution of the command from all administrators.

10. The method according to claim 8, further including the step of preparing a virtual logical storage system that represents a configuration of one of the logically partitioned storage systems if the command is executed.

11. The method according to claim 10, further including the step of importing the configuration of the virtual logical storage system by one of said logically partitioned storage systems if the command is authorized by administrators of said first and second logically partitioned storage systems.

12. The method according to claim 8, further comprising the steps of authenticating the administrators by a management interface prior to the administrators being allowed to authorize the command.

13. A storage system comprising:
a first logical storage system accessible by a first host; and
a second logical storage system accessible by a second host;
wherein the first host does not have access to the second logical storage system and the second host does not have access to the first logical storage system, and
wherein upon receiving a command from the first host that requires access to resources in the second logical storage system, the command is permitted only after receiving authorization from a first administrator of the first and a second administrator of the second logical storage systems.

14. The storage system according to claim 13, further comprising:
a first command interface contained in the first logical storage system; and
a second command interface contained in the second logical storage system,
wherein the command is executed after the first and second command interfaces confirm that the command is permitted by referring to a predefined table.

15. The storage system according to claim 13, wherein each of the first and second logical storage systems include a table indicating whether a particular command is authorized.

16. The storage system according to claim 13, wherein a management interface includes a predefined table containing commands that are authorized to be executed across the logical storage systems.

17. The storage system according to claim 16, wherein the administrators of the logical storage systems are authenticated by the management interface prior to being allowed to authorize the command.

18. The storage system according to claim 13, wherein a virtual logical storage system is created by a user of said first logical storage system to specify a configuration of the second logical storage system for executing the command.

19. The storage system according to claim 18, wherein if the administrator of the second logical storage system authorizes the command, the configuration of the virtual logical storage system is imported to the second logical storage system.

20. A method of executing a command across logical partitions in a storage system comprising the steps of:
providing a first logically partitioned storage system having a first administrator and a second logically partitioned storage system having a second administrator, as first and second logical partitions, respectively;
specifying, by the first administrator, requirements for resources of the second logically partitioned storage system for executing the command across the logical partitions;
allocating resources by the second administrator in accordance with the specified requirements if the second administrator authorizes execution of the command.

21. The method according to claim 20, further including the step of:
specifying, by the first administrator, the requirements for resources to a management interface, said management interface then notifying the second administrator of the requirements.

22. The method according to claim 20, further including the steps of:
authenticating the first and second administrators by a management interface prior to the administrators being allowed to authorize the command.
